(19) United States
(12) Patent Application Publication
(10) Pub. No.: US 2011/0160336 A1
(43) Pub. Date: Jun. 30, 2011

(54) METHOD OF USE OF A POLYVINYL ALCOHOL-BASED COMPOSITION

(76) Inventors: Roland REICHENBACH-KLINKE, Traunstein (DE); Peter Lange, Obing (DE); Christian Spindler, Ludwigshafen (DE); Gregor Keilhofer, Tacherting (DE)

(21) Appl. No.: 13/033,686

(22) Filed: Feb. 24, 2011

Related U.S. Application Data
(63) Continuation-in-part of application No. 11/973,893, filed on Oct. 10, 2007, now abandoned.
Application No. 11/973,893 is a continuation-in-part of application No. PCT/EP2007/060446, filed on Oct. 2, 2007.

(30) Foreign Application Priority Data
Oct. 5, 2006 (DE) 10 2006 047 091.5

(51) Int. Cl. C09K 8/467

(52) U.S. Cl. 523/130

(57) ABSTRACT

A composition based on polyvinyl alcohol and a sulfonated ketone/formaldehyde condensate in the preferred mixing ratio of 1:1 as a further component, is provided as a fluid loss additive in mixtures containing hydraulic binders.

This application is a continuation-in-part application under 35 U.S.C. §119 from U.S. Ser. No. 11/973,893 filed Oct. 10, 2007, which is a continuation-in-part of and claims priority under 35 U.S.C. §120 from PCT/EP2007/060446 filed Oct. 2, 2007, which claims priority from DE 102006047091.5 filed Oct. 5, 2006. Each of these is incorporated herein by reference in its entirety.

### FIELD OF THE INVENTION

The present invention relates to the method of use of a polyvinyl alcohol-based composition as a fluid loss additive.

### BACKGROUND OF THE INVENTION

The use of polyvinyl alcohol (PVA) has been sufficiently described previously especially in construction chemistry applications.

In particular, the use as so-called fluid loss additive in the cementing of oil and gas wells is widely known. In this context, reference may be made by way of example to U.S. Pat. No. 2,576,955, which discloses a cement composition which, in addition to the cement component, contains polyvinyl alcohol as a fluid loss additive and tributyl phosphate and pine oil as antifoaming agents.

In the cementing of wells, the use of fluid loss additives which reduce and completely prevent the escape of water from slurries of inorganic or organic binders is essential since the cement slurries have to be pumped over long distances, initially through the so-called casing, a metal pipe, to the bottom of the well and then through the gap between casing and formation back to the earth's surface. Over this relatively long distance, the water content of the cement slurry cannot be permitted to decrease too greatly, since correct setting of the cement would then not be possible and the cement could no longer perform its desired tasks, e.g., the strong, permanent binding of the casings to the formation and the sealing of the space between casing and formation with respect to gases and liquid which may be liberated from the ground formation through the drilling. The water loss is typically caused by capillary forces, which emanate from porous subsoil, and the hydrostatic pressure of the cement column. Fluid loss additives can either bind water to themselves due to their chemical structure or promote the formation of a dense filtercake on the subsoil.

U.S. Pat. No. 4,569,395 likewise discloses a cement-containing composition which can also be used for cementing wells. The composition described therein is said to show improved performance properties over a broad temperature range and it contains a polyvinyl acetate/polyvinyl alcohol copolymer which is insoluble in the slurry at room temperatures. The content of acetate groups converted into hydroxyl groups is >95%. Under the special conditions of the pumping temperatures, i.e. at high temperatures, this polymer goes into solution, it thickens the slurry stepwise and thus suppresses negative effects, such as the thermally caused dilution, fluid loss behavior and settling movements of heavy substances.

Polyvinyl alcohol is usually obtained by hydrolysis of polymerized vinyl acetate, a distinction being made between different PVA types according to the degree of hydrolysis. The most widely known PVA types are cold water-soluble members having degrees of hydrolysis up to about 90%. The second PVA type is only slightly soluble in cold water whereas it has pronounced solubility under hot water conditions. In this case, the degree of hydrolysis is about 99%.

In practice, a multiplicity of other additives, such as, for example, dispersants, retarders or antifoaming agents, are often also added to the cement slurries which contain PVA as a fluid loss additive. Suitable typical dispersants in this context are in particular sulfonated naphthalene/formaldehyde resins since these are very compatible with PVA.

Reference is made here to the abovementioned U.S. Pat. No. 4,569,395. The composition described there and already presented for well cementing contains, in addition to the polyvinyl acetate/polyvinyl alcohol polymer, cellulose-containing materials, polysaccharides, polyacrylamides, polyacrylonitriles and other compounds as fluid loss additives which can additionally be mixed with compounds having a dispersing effect. Anionic and surface-active compounds of the type consisting of sulfonated naphthalene compounds are mentioned as typical dispersants. Such materials are typically distinguished by a low molecular weight in the range from about 1000 to 3000 g/mol.

The use of PVA as a fluid loss additive together with a sulfonated naphthalene/formaldehyde resin as a dispersant is also disclosed in U.S. Pat. No. 5,105,885.

The most relevant disadvantage of PVA is in general the requirement of relatively large amounts of this compound as active substance in order to achieve the desired low fluid-loss effect. Especially at relatively high temperatures >50° C. (>120° F.), this disadvantageous behavior is very pronounced. This furthermore leads to the fact that the cost benefit of the essentially economical polymer PVA is canceled out by the use of large amounts.

In practice, it is therefore desired to increase the effectiveness of the PVA by the addition of coadditives in order thus to compensate the required larger amounts of PVA. It is known that the action of PVA as a fluid loss additive can be increased by the addition of surfactants. U.S. Pat. No. 5,207,831 describes, for example, the addition of a surface-active agent to a cement-containing composition which contains a polymer as a fluid loss additive. In this way, it is intended synergistically to reduce the water loss from the chemical construction composition prior to its hardening.

The fluid loss behavior of PVA can, however, also be optimized by combination with other fluid loss additives. Such additives based on 2-acrylamido-2-methylpropanesulfonic acid (AMPS) are disclosed, for example, in US 2006/0041060 and, together with a polyvinyl alcohol resin, are intended to improve the water retention of hydraulic cement. For economical reasons, the use of such coadditives in turn is not optimal since they are substantially more expensive than PVA, and, in this case too, the cost benefit generally associated with the use of PVA is therefore canceled out.

DE 43 21 070 A1 discloses redispersible dispersion powder compositions which contain four components altogether, polyvinyl alcohol having a degree of hydrolysis of from 85 to 95 mol % being stated as component b). Furthermore, it is disclosed that the dispersion powder composition may also contain up to 30% by weight of cement plasticizers, condensates of melamine or ketone and formaldehyde which contain sulfonate groups being mentioned in particular. The dispersion powder compositions described are suitable for use in building materials and in particular in dry mortars which contain Portland cement as an inorganic binder, and lead to an increased adhesive strength of the mortars there.

DE 40 30 638 A1 also discloses a four-component dispersion powder composition which contains polyvinyl alcohol as component b). In addition, reference is made to condensates containing sulfonate groups, inter alia of ketone and formaldehyde. Such compositions are used in leveling, hydraulically setting filling compounds in construction adhesives, in mortars as a gypsum additive, in plasters and emulsion paints.

Finally, European patent application 0 587 383 A1 mentions polyvinyl alcohol as a binder constituent of a cement-containing material which may additionally comprise sulfonated acetone/formaldehyde condensates.

### OBJECTS OF THE INVENTION

On the basis of the prior art described, there is still a need in the art for economical fluid loss additives based on the main component PVA, for which the effectiveness is substantially increased by the addition of likewise economical coadditives.

This object was achieved by adding a composition comprising polyvinyl alcohol or one of its derivatives as component a) in combination with a sulfonated ketone/formaldehyde condensate as component b) wherein the composition is used as a fluid loss additive in a mixture containing a hydraulic binder.

### DETAILED DESCRIPTION

According to DE 33 44 291 A1, sulfonated ketone/formaldehyde condensates are prepared by condensation of a ketone component, such as, for example, acetone, with formaldehyde and a compound introducing acid groups, such as, for example, sodium sulfite, at elevated temperature. A variant of these condensation resins is described in WO 2004/052960 A1. Here, sulfonated ketone/formaldehyde condensates are copolymerized with a polyamide backbone. WO 2004/052960 is a substantial part of the present disclosure with regard to these copolymers.

According to the object, the effectiveness of polyvinyl alcohol as a fluid loss additive can now be substantially increased when combined with the sulfonated acetone/formaldehyde condensate (component b). This substantiveness was particularly surprising since the sulfonated ketone/formaldehyde resins used as component b) are usually used as dispersants (cf. U.S. Pat. No. 4,557,763 and DE 33 44 291 A1). Furthermore, there is the fact that, in addition to the improved effect of PVA as a fluid loss additive, the water retention of cement slurries which contain standard dispersants, such as, for example, β-naphthalenesulfonic acid/formaldehyde resin, can generally also be improved. In other words, the effect of PVA as a fluid loss additive can unexpectedly be substantially increased in the present case by combination with a component which to date was known to act exclusively as a dispersant, without, however, the effect thereof as a flow improver being diminished or lost thereby or the effect of other dispersants likewise present being adversely influenced.

In a preferred embodiment the composition contains as component a) polymers which can be converted by hydrolysis into polyvinyl alcohol, e.g., polyvinyl ester or preferably polyvinyl acetate, in proportions up to 90% by weight and preferably in proportions of from 5 to 20% by weight. These proportions, for example of polyvinyl acetate, correlate directly with the degree of hydrolysis thereof. For this reason, the concomitantly used component a), namely the polyvinyl alcohol component, should also have a degree of hydrolysis of from 10 to 100% and in particular from 80 to 95%. Overall, a composition in which the component a) has a molar mass M̅ₙ>5,000 g/mol and preferably >50,000 g/mol is to be regarded as being particularly suitable.

Particularly preferred is an embodiment in which the composition according to the invention contains as component b) a sulfonated acetone/formaldehyde condensate which can be also be grafted onto the backbone of a copolymer. Inter alia, water-soluble polyamide-based copolymers, as disclosed in WO 2004/052960, are suitable here.

A further variant of the composition according to the invention contains, as component a), copolymers of polyvinyl alcohol and sulfonated monomers, as described, for example, in US 2005/0065272 A1. The relevant disclosure of which is an integral part of this description. Of course, it is also possible to use such copolymers in combination with PVA as component a).

Overall, components a) and b) should be present in the claimed composition in the mixing ratio of from 10:1 to 1:10, preferably from 5:1 to 2:3 and in particular in the ratio 1:1. A preferred ratio between component a) and component b) is 1:1. A ratio of component a) to component b) of 1.1:1 to 1:2 is also preferred.

An additional embodiment is a method of use of the composition described above in the development, exploitation and completion of subterranean mineral oil and natural gas deposits.

In general, it is advisable to mix the composition described in the form of a prepared mixture into a slurry containing at least one hydraulic binder. However, the invention also covers the possibility of adding the two components a) and b) individual components, i.e. separately from one another, to the slurries. Also comprised is the variant in which one of the components a) or b) is already the constituent of a slurry, into which the respective other component b) or a) is then mixed; in the last-mentioned case, the slurry containing components a) and b) is therefore the actual composition.

In association with the present invention, the expression “hydraulic binders” is understood as meaning in particular cements and especially inorganic cements which harden under the influence of water. This definition therefore covers Portland cements, Portland composite cements, blast-furnace cements, high-alumina cements and puzzolanes, it also being possible for these binder components to contain fillers, such as bentonites, silicates, silica, limestone powder and gilsonite. Such mixtures based on hydraulic binders usually also contain aggregates, such as sand or relatively coarse-grained aggregates.

The claimed method of use can also be effected, according to the invention, together with crosslinking agents suitable for polyvinyl alcohols, including in particular boric acid and salts thereof.

Finally, the present invention also covers an embodiment in which the use is effected together with customary cement additives, such as, for example, dispersants, retarders, thickeners, accelerators or other fluid loss additives.

In particular, the present invention provides for the use of a synergistic composition in which the fluid loss effect of PVA, which is known to be good, is substantially increased by a component known to date exclusively as a dispersant. This use is of interest in particular also in terms of economic aspects since the known cost benefit of PVA can continued be utilized. In addition, there is the possibility of positively influencing the flow behavior of chemical construction compositions taking into account further standard dispersants.

The following examples illustrate the advantages of the present invention.

### EXAMPLES

The fluid loss values were determined according to API standard 10A.

### Example 1

A combination of high molecular weight polyvinyl alcohol (PVA) (degree of hydrolysis about 88%) and an acetone/formaldehyde/sulfite condensate (Liquiment K3F from BASF Construction Polymers GmbH) was used in the following test system:

Test system: 800 g of Class G cement (Dyckerhoff)

352 g of distilled H₂O

1 g of tributyl phosphate (antifoaming agent)

Temperature: 125° F.

Examples 1.1 to 1.6: Comparison according to the prior art; examples 1.7 to 1.10: invention

| | | Liquiment K3F dose | |
|---|---|---|---|
| Example | PVA dose [% bwoc] | [% bwoc] | Fluid loss [ml] |
| 1.1 | 0.7 | — | >1000 (theor.) |
| 1.2 | 0.8 | — | >1000 (theor.) |
| 1.3 | 0.9 | — | >1000 (theor.) |
| 1.4 | 1.0 | — | 830 (theor.) |
| 1.5 | 1.2 | — | 803 (theor.) |
| 1.6 | 2.4 | — | 255 (theor.) |
| 1.7 | 0.7 | 0.2 | 49 |
| 1.8 | 0.8 | 0.2 | 35 |
| 1.9 | 0.9 | 0.2 | 48 |
| 1.10 | 1.0 | 0.2 | 36 |

% bwoc = percent by weight of composition

This example clearly shows that the effect of the PVA as component a) is substantially improved even by the addition of a small amount of acetone/formaldehyde/sulfite condensate as component b).

### Example 2

This example illustrates that the positive effect on the fluid loss behavior can be achieved exclusively with a sulfonated ketone/formaldehyde condensate but not with any arbitrary dispersant. As reference herein the standard dispersant β-naphthalene sulfonic acid/formaldehyde condensate (NSF), widely used in the oil field sector, was used.

Test system: 800 g of Class G cement (Dyckerhoff)
352 g of distilled H₂O
1 g of tributyl phosphate (antifoaming agent)

Temperature: 140° F.

| | PVA dose | Liquiment K3F | NSF dose | |
|---|---|---|---|---|
| | [% bwoc] | dose [% bwoc] | [% bwoc] | Fluid loss [ml] |
| Comparison | 0.5 | — | 0.5 | >1000 (theor.) |
| Invention | 0.5 | 0.5 | — | 76 |

### Example 3

A substantial influence on the fluid loss behavior can be achieved by the targeted choice of the mixing ratio of the two components a) and b), with a constant total amount:

Test system: 700 g of Class H cement (Lafarge)
266 g of distilled H₂O
1 g of tributyl phosphate (antifoaming agent)

Temperature: 140° F.

| | Liquiment K3F dose | |
|---|---|---|
| PVA dose [% bwoc] | [% bwoc] | Fluid loss [ml] |
| 0.45 | 0.35 | 420 (theor.) |
| 0.35 | 0.4 | 24 |
| 0.3 | 0.45 | 40 |

### Example 4

This example shows that the combination of polyvinyl alcohol with acetone/formaldehyde condensates which are grafted onto a copolymer (Liquiment® Bio from BASF Construction Polymers GmbH) also has advantageous fluid loss properties.

Furthermore, it is illustrated that the composition according to the invention is also effective in combination with other conventional cement additives and customary crosslinking agents for polyvinyl alcohols.

Test system: 800 g of Class G cement (Dyckerhoff)
352 g of distilled H₂O
1 g of tributyl phosphate (antifoaming agent)

Temperature: 140° F.

| | Dose | Fluid loss |
|---|---|---|
| Fluid loss additive | [% bwoc] | [ml] |
| PVA/Liquiment ® K3F with 2% of a | 1.0 | 285 theor. |
| high molecular weight HEC as | 1.1 | 48 |
| thickener and 2% of boric acid as | 1.2 | 46 |
| crosslinking agent | | |
| PVA/Liquiment ® K3F with 1% of a | 1.0 | 527 theor. |
| high molecular weight HEC as | 1.1 | 64 |
| thickener | 1.2 | 40 |
| PVA/Liquiment ® Bio | 0.6 | 808 theor. |
| | 0.7 | 10 |
| PVA/Liquiment ® K3F | 0.7 | 645 theor. |
| | 0.9 | 108 |
| | 1.0 | 42 |
| | 1.1 | 32 |

HEC: Hydroxyethylcellulose

### Example 5

In this example, the fluid loss of the composition in accordance with the invention is compared with the fluid loss of the composition not containing boric acid.

Test system: basic slurry contains
600 g of Lafarge Class H
12 g of PVA
276 g of Water
1 g of TBP

Temperature: 100° F.

| | | Rheologie Fann 35 | | | | | | |
|---|---|---|---|---|---|---|---|---|
| | Fluid Loss Additive | 300 | 200 | 10 | 6 | 3 | 600 | Fluid Loss [ml] |
| Comparison | 49% Mowiol | 157 | 101 | 48 | 4 | 3 | 297 | 54 |
| | 49% Liquiment K3F | | | | | | | |
| | 2% Tylose | | | | | | | |
| Invention | 48% Mowiol | 143 | 96 | 48 | 4 | 2 | 256 | 26 |
| | 48% Liquiment K3F | | | | | | | |
| | 2% Boric Acid | | | | | | | |
| | 2% Tylose | | | | | | | |

Lafarge Class H: Cement
PVA: Polyvinylalcohol
TBP: Tributylphosphate (anti foaming agent)
Mowiol: PVA
Liquiment K3F: Product of BASF Construction Polymers GmbH (Fluid loss controlling agent; friction reducer)
Tylose: Thickener; thixotroping/anti-settling agent
Boric Acid Cross-linker

This example shows that the fluid loss of the composition in accordance with the invention is about half in comparison to the fluid loss of the composition not containing boric acid.

This example clearly shows that the combination of polyvinyl alcohol with boric acid has advantageous fluid loss properties.

Any and all references cited herein are hereby incorporated herein by reference in their entireties.

1. A method comprising adding to a composition comprising a hydraulic binder, a polyvinyl alcohol or a derivative thereof as component a) and a crosslinking agent suitable for crosslinking polyvinyl alcohol as component b) to decrease the amount of fluid loss in a mixture containing a hydraulic binder compared to a composition without component b).

2. The method of claim 1, wherein the component b) is boric acid or a salt thereof.

3. The method of claim 1, wherein the component a) is a polymer which hydrolyzes to yield polyvinyl alcohol.

4. The method of claim 1, wherein the component a) used has a molar mass M̅ₙ>5000 g/mol.

5. The method of claim 1, wherein the component a) is a copolymer of polyvinyl alcohol with sulfonated monomers.

6. The method of claim 3, wherein the component a) is polyvinyl ester or polyvinyl acetate.

7. The method of claim 1, further comprising adding to the composition a cement additive.

8. The method of claim 7, wherein the cement additive is a dispersant, a retarder, a thickener, an accelerator or a fluid loss additive, wherein the cement additive is different than the components a) and b).

9. The method of claim 1, further comprising adding to the composition a sulfonated acetone/formaldehyde condensate.

10. The method of claim 9 wherein component a) is presenting an amount of from at least some up to 90% by weight of the composition.

11. The method of claim 9, wherein component a) is present in an amount of from 5 to 20% by weight.

12. The method of claim 9, wherein the sulfonated acetone/formaldehyde condensate is grafted onto a copolymer.

13. The method of claim 9, wherein the components a) and the added sulfonated acetone/formaldehyde condensate are present in a weight ratio of from 10:1 to 1:10.

14. The method of claim 9, wherein the components a) and the added sulfonated acetone/formaldehyde condensate are present in a weight ratio of from 5:1 to 2:3.

15. The method of claim 9, wherein the components a) and the added sulfonated acetone/formaldehyde condensate are present in a weight ratio of from 1.1:1 to 2:1.

16. The method of claim 9, wherein the components a) and the added sulfonated acetone/formaldehyde condensate are present in a weight ratio of 1:1.

17. The method of claim 9, further comprising adding to the composition a cement additive.

18. The method of claim 17, wherein the cement additive is a dispersant, a retarder, a thickener, an accelerator or a fluid loss additive, wherein the cement additive is different than the component a), component b), and the added sulfonated acetone/formaldehyde condensate.

19. A method comprising, developing, exploiting or completing a subterranean mineral oil or natural gas deposit by injecting the composition prepared by the method of claim 19 into the subterranean mineral oil or natural gas deposit.

20. The method of claim 19, wherein the components a) and b) are added individually or as a pre-mix comprising the components a) and b) into a slurry containing a hydraulic binder.

21. A hydraulic binder containing composition, comprising a polyvinyl alcohol or a derivative thereof as component a) and a crosslinking agent suitable for crosslinking polyvinyl alcohol as component b) to decrease the amount of fluid loss in a mixture containing a hydraulic binder compared to a composition without component b).

22. A method comprising decreasing the amount of fluid loss in a mixture containing a hydraulic binder comprising adding to a mixture containing a hydraulic binder and having fluid loss a polyvinyl alcohol or a derivative thereof, crosslinking agent suitable for crosslinking polyvinyl alcohol.

23. The method of claim 21, wherein the crosslinking agent is boric acid or a salt thereof.

24. The method of claim 22, wherein the crosslinking agent is boric acid or a salt thereof.
